(19) United States
(12) Patent Application Publication
(10) Pub. No.: US 2009/0027928 A1
(43) Pub. Date: Jan. 29, 2009

(54) STEP UP CONVERTER WITH OVERCURRENT PROTECTION

(76) Inventors: Xiaopeng Dong, ShenZhen (CN); Chaojun Zhu, ShenZhen (CN)

Correspondence Address: PERKINS COIE LLP;PATENT-SEA, P.O. BOX 1247, SEATTLE, WA, 98111-1247, US

(21) Appl. No.: 12/180,756

(22) Filed: Jul. 28, 2008

(30) Foreign Application Priority Data
Jul. 28, 2007 (CN) 200710044337.2

(51) Int. Cl. H02H 9/02

(52) U.S. Cl. 363/50

(57) ABSTRACT

A step up converter with overcurrent protection is disclosed. The step up converter can precisely limit the output current of the upstream device. Current from the input terminal of the converter is detected and compared with a predetermined maximum current to get a comparison value which is delivered to a close-loop regulator. The overcurrent protection is achieved by the regulator outputting a control signal to fulfill the conduction or resistance increase of a resistive element of the protection circuit. Furthermore, detection of the temperature or the output voltage may trigger shut off of the protection circuit to implement a protection function.

### RELATED APPLICATION(S)

This application claims priority to Chinese patent application No. 200710044337.2 entitled “A STEP UP CONVERTER WITH OVERCURRENT PROTECTION”, filed on Jul. 28, 2007.

### TECHNICAL FIELD

This invention relates to a step up converter with overcurrent protection, and more particularly, to a step up converter which limits the output current of an upstream device.

### BACKGROUND

Many consumer electronic devices are now charged not through the use of an external dedicated charger, but rather through a USB charger. The use of a USB charger eliminates the need for an AC power outlet which is required by traditional chargers. Further, the USB charger can obtain the power directly from a computer or other device with a USB port.

A USB port typically can deliver a voltage of 5V and a maximum current of 500 mA. If the load causes the current to rise above the maximum value, the USB port and the mainboard may be damaged. It is important to ensure normal operation of the USB charger and at the same time realize the maximum power output. Prior art attempts to limit the current from a USB port utilize a current limiting integrated circuit (IC) on the mainboard. Another prior art technique of overcurrent protection is achieved by integrating the current limiting circuit with the charger circuit. An example of this is shown in U.S. Pat. No. 6,664,765 entitled “Lithium-ion Battery Charger Power Limitation Method”. The '765 patent compares the power, voltage and current and shifts among the three modes to achieve current limiting. This current limiting function is realized in the charger circuit and the current limiting circuit cannot be used in other devices with an internal charging control circuit.

### BRIEF DESCRIPTION OF THE DRAWINGS

FIG. 1 illustrates a block diagram of a step up converter with overcurrent protection function in accordance with a disclosed embodiment.

FIG. 2 illustrates a schematic input current detection circuit unit in accordance with a disclosed embodiment.

FIG. 3 illustrates a schematic step-up circuit unit in accordance with a disclosed embodiment.

FIG. 4 illustrates a schematic protection circuit unit in accordance with a disclosed embodiment wherein FIG. 4(a) is a BJT and FIG. 4(b) is a MOSFET.

FIG. 5 illustrates a schematic auxiliary power supply unit in accordance with a disclosed embodiment.

FIG. 6 illustrates a schematic close-loop regulator of the control circuit in accordance with a disclosed embodiment.

FIG. 7 illustrates a schematic control circuit in accordance with a disclosed embodiment.

### DETAILED DESCRIPTION

Disclose is a step up converter with overcurrent protection function for a USB port and which limits the output current delivered to a device that includes internal charging control circuitry.

In one embodiment, a current limiting step up converter comprises: an input terminal, connected to the power supply device (such as USB port); an output terminal, delivering current to the load; an input current detection circuit, connected to said input terminal, sensing the input current of the input terminal and sending a current detection signal to a control circuit. The control circuit is connected to the input current detection circuit which generates a maximum current reference signal representing a predetermined maximum current by an internal maximum current reference generator. The current detection signal is compared with the maximum current reference signal to get a comparison signal which is sent to a close-loop regulator for outputing a control signal to adjust the resistance of the protection circuit.

The step up converter may also comprise an auxiliary power source, supplying power to the protection circuit and the control circuit. When the current detection signal is less than the maximum current reference signal, the resistance of the protection circuit is decreased by the control circuit to achieve a desired power delivered to the load. When the current detection signal reaches the maximum current reference signal, the resistance of the protection circuit is dynamically adjusted by the control circuit to maintain the input current at the predetermined maximum current.

The step-up circuit of the step up converter may be a boost converter, increasing the voltage of the USB port to a level required by the load and delivering the regulated voltage to the protection circuit. The current limiting step up converter further includes an auxiliary power supply, coupled to the switch node (SW) of the step-up circuit and input terminal, and to supply power to the protection circuit and the control circuit. The auxiliary power supply may be a charge pump. The input current detection circuit detects the input current from the input terminal by sensing the voltage a resistance device such as a simple resistor, the “on” resistance of a switching element or the DC resistance of the inductive device of the step-up circuit. The switching element of the protection circuit can be a BJT or a MOSFET.

The control circuit may further comprise an output voltage detection circuit. When the output is shorted for a time, a protection circuit is triggered by the control circuit to protect the charger.

The control circuit may further comprise a temperature detection circuit. When the temperature is higher than a predetermined value, a protection circuit is triggered to protect the charger.

Now the invention will be described by the following detailed description in combination with the drawings.

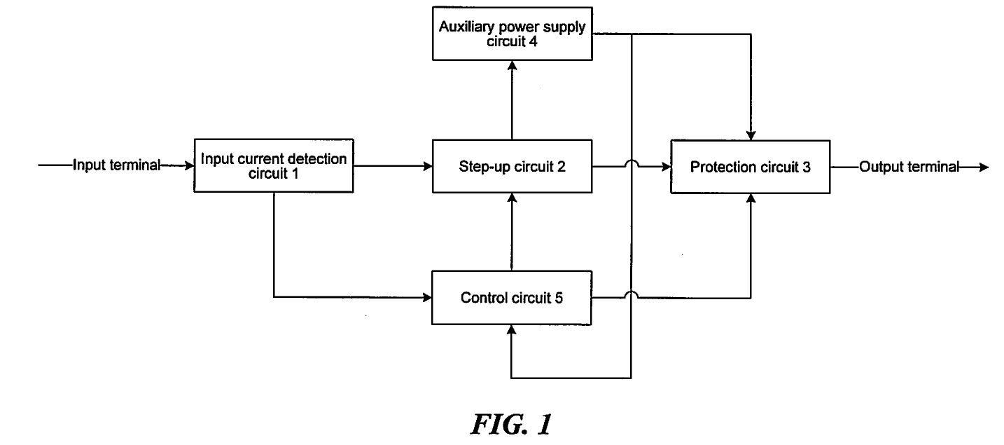

According to FIG. 1, a step up converter with overcurrent protection is illustrated. As shown, the input terminal, input current detection circuit 1, step-up circuit 2, protection circuit 3, and the output terminal are all connected in serial. The input current detection circuit 1 is further coupled to a control circuit 5. The control circuit 5 is coupled to the step-up circuit 2 and protection circuit 3. The step-up circuit 2 is coupled to an auxiliary power supply circuit 4. The auxiliary power supply is coupled to the protection circuit 3 and the control circuit 5.

When the input terminal is electrically coupled to a USB port, the input current detection circuit 1 begins to continuously detect the current provided by the USB port which is also the input current of the step up converter. The input current detection circuit sends a current detection signal to the control circuit 5. Based upon the current detection signal, the control circuit 5 controls the status of protection circuit 3 to limit the current at the output terminal, thereby in turn limiting the current at the input terminal. The step-up circuit 2 is used to boost the voltage at the input terminal to the level required by the load and then outputs the boosted voltage to the load through the protection circuit 3. The load coupled to the output terminal may be a USB charger or other device with charging control circuitry. Moreover, the step up converter further comprises an auxiliary power supply circuit 4 which supplies power to the control circuit 5 and the protection circuit 3.

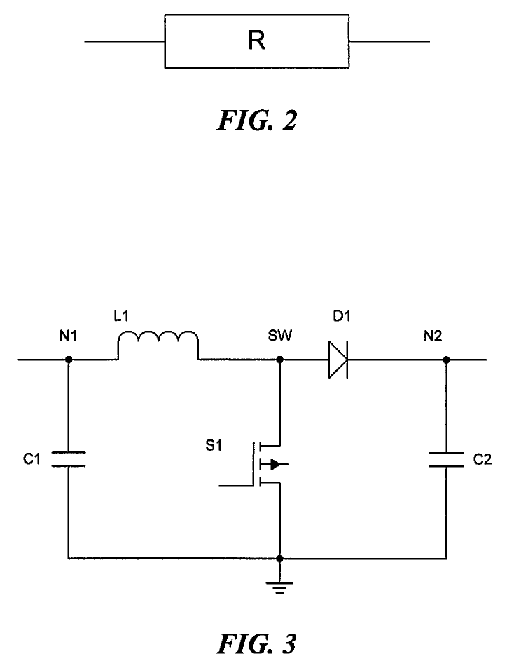

Referring to FIG. 2, the input current detection circuit 1 may be a simple resistor R, the conduction resistance of a switching element, or the DC resistance of the inductive device in the step-up circuit 2. The input current detection circuit 1 senses the input current by sensing the voltage drop across the resistive devices described above.

Referring to FIG. 3, the step-up circuit 2 may be a boost converter, which comprises an inductor L1, switch S1, rectifier diode D1, input capacitor C1 and output capacitor C2. By controlling the duty cycle of the switch S1, the boost converter boosts the voltage at node N1 to the level required by the load at node N2. This voltage is filtered by the output capacitor C2. Node N1 connects to the input current detection circuit 1. The voltage at node N1 is determined by the voltage at the input terminal (Vin) and the resistive value (R) of the input current detection circuit 1 as: VN1=Vin−I*R. R is selected to be small, which results in VN1 almost being the same as Vin.

When the input current detection circuit 1 uses the DC resistance of inductor L1, the voltage at node N1 equals to Vin. In other words, the resistive element R may be in fact the inductor L1 which serves dual purposes: (1) resistive element R and (2) inductor for the step-up boost circuit. This has the advantage of eliminating one element from the embodiment.

The node between the inductor L1 and the anode of the diode D1 is a switch node (SW), which delivers a switching signal to the auxiliary power supply circuit 4. While the step-up circuit 2 begins operation, the auxiliary power supply circuit 4 operates. The auxiliary power supply circuit 4 is a charge pump which uses the switching signal of step-up circuit 2 at the switch node (SW) and the input voltage at input terminal to for auxiliary power.

Referring to FIG. 5, the auxiliary power supply circuit 4 may be a charge pump. The charge pump comprises diodes D2, D3 and capacitors C3, C4 wherein the anode of diode D2 connects to IN terminal, C3 has one end connected to the cathode of D2 and anode of D3 and the other end connected to the SW terminal, C4 has one end connected to the cathode of D3 and the other end connected to the ground GND. A Vbias terminal connects to the cathode of D3 and delivers power to the control circuit 5 and protection circuit 3. The IN terminal connects the input terminal (also the USB port terminal) which has the voltage of Vin, and the SW terminal connects the SW node of the step-up circuit 2. When the step-up circuit 2 operates, SW terminal has a high or low level pattern. When the signal at SW terminal is low, C3 is charged to Vin. When SW terminal is high (such as 6 volts), C4 is charged to be a sum of the voltage of C3 and the SW, that is Vc4=Vc3+Vsw=Vin+Vsw, and gets an auxiliary voltage of about 10 volts to supply the protection circuit 3 and the control circuit 5.

The input current changes according to the resistance of the load. When the resistance of the load decreases, the input current increases. When the resistance increases, the input current decreases. The protection circuit 3 and the load are connected in serial to form the load of the step-up circuit 2. The load of the step-up circuit 2 is changed by controlling the resistance of the protection circuit 3, so as to control the input current of the step up converter. This principle is used to limit the current on the USB port (input current).

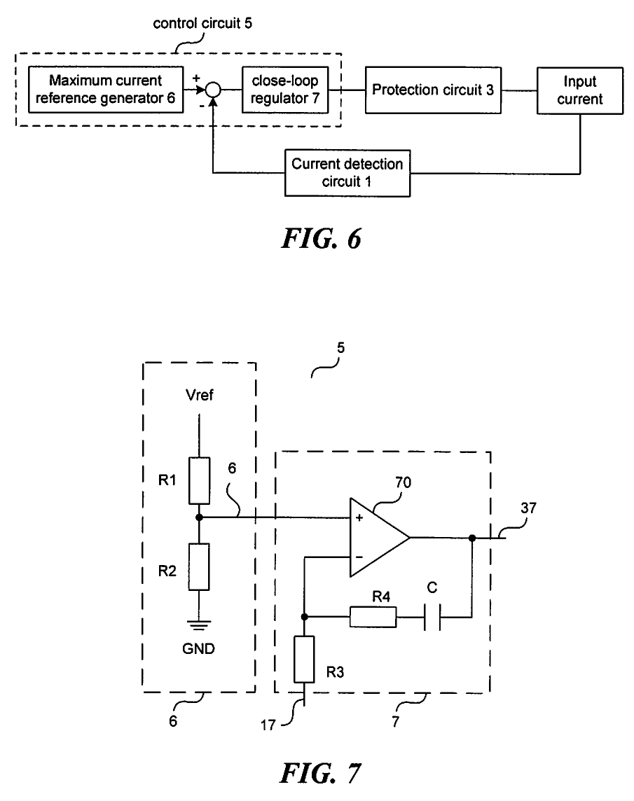

Referring to FIG. 6, the input current detection circuit 1 sends a current detection signal to the control circuit 5. The control circuit 5 has an internal maximum current reference generator 6 which offers a predetermined maximum current reference signal representing the predetermined maximum current. Then the current detection signal is compared to the maximum current reference signal to get a comparison signal which is sent to the close-loop regulator 7 of the control circuit 5. According to the comparison signal, the close-loop regulator 7 outputs a control signal to drive the protection circuit 3. The protection circuit 3 comprises a switching element (a resistive element) which is connected with the load. The resistance of the resistive element is controlled by the control signal. The load in one embodiment can be a lithium-ion battery charger.

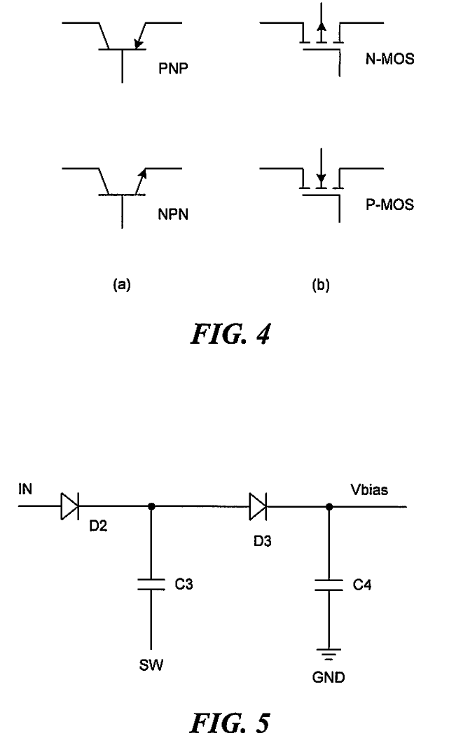

Referring to FIG. 4, the resistive device of the protection circuit may be a BJT (FIG. 4(b)) or a MOSFET (FIG. 4(b)) in according to an embodiment of the present invention. The close-loop regulator outputs the control signal according to the comparison signal and adjusts the resistance of the switching element of protection circuit 3 to limit the current. In practice, when the input current is less than the predetermined maximum current, the control signal from the close-loop regulator 7 controls the switching element of the protection circuit to be totally turned on, which allows minimal resistance and allows the converter to supply a desired power to the load.

As the resistance of the load decreases, the input current increases. When the input current increases to be the same as the maximum current, that is, the current detection signal reaches the maximum current reference signal, the resistance of protection circuit 3 is dynamically adjusted by the control circuit 5 to maintain the input current at the predetermined maximum current.

FIG. 7 shows the schematic close-loop regulator 7 and the maximum current reference generator 6 of the control circuit 5. The maximum current reference generator 6 comprises voltage divider resistors R1 and R2 connected in series. One end of R2 connects to ground GND, and one end of R1 receives a reference voltage Vref. The maximum current reference signal is obtained from the connection node of R1 and R2. By changing the values of R1 and R2, the predetermined maximum current may be set. The close-loop regulator 7 comprises a comparator 70, a close-loop feedback network consisting of resistor R4 and capacitor C. The non-inverting input of the comparator 70 receives the maximum current reference signal. The inverting input of the comparator 70 receives the current detection signal 17 through resistor R3.

The output 37 of the comparator 70 connects with the gate of the switching element of the protection circuit 3. Comparator 70 compares the current detection signal with the maximum current reference signal. When the current detection signal is less than the maximum current reference signal, the close-loop regulator 7 outputs a high voltage to turn on the switching element of the protection circuit 3; and when the current detection signal surpasses the maximum current reference signal, close-loop regulator 7 outputs a voltage which leads the switching element of the protection circuit working under the linear region and maintain the input current at the maximum current.

The control circuit 5 may further comprise an output voltage detection circuit to detect the output voltage. When the output terminal is shorted for a certain time, the resistive element of the protection circuit 3 would become the actual load of the entire circuit. In a short circuit condition, all the energy is converted to heat and would damage the circuit. Thus, the close-loop regulator 7 delivers a control signal to cut off the resistive element of the protection circuit 3. The control circuit 5 further may comprise yet another circuit for temperature detection to detect the system temperature. When the temperature is higher than a predetermined value, the resistive element may be cut off by the control circuit 5.

Many modifications and variations of the present invention are possible in light of the above teachings. It is therefore to be understood that within the scope of the appended claims, the invention may be practiced otherwise than as specifically described. For example, the disclosure herein is mainly in the context of a USB charger, but one skilled in the art should know that the invention can also be used with other applications with internal charging control circuitry. It should be understood, of course, the foregoing disclosure relates only to a specific embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A step up converter comprising:
an input terminal for connection to a port;
an output terminal for delivering current to a load;
an input current detection circuit coupled to said input terminal and for outputting a current detection signal;
a control circuit coupled to said input current detection circuit and receiving the current detection signal, the control circuit comparing said current detection signal with a maximum current reference signal and outputting a control signal;
a step-up circuit coupled to said input current detection circuit, the step up circuit boosting the voltage at said input terminal to a level required by the load; and
a protection circuit coupled between the step-up circuit and said output terminal, the protection circuit receiving the control signal, and responsive thereto, operative to selectively adjust the resistance of said protection circuit.

2. The step up converter in claim 1, wherein when said current detection signal is less than said maximum current reference signal, the resistance of the protection circuit is decreased by said control circuit to achieve a desired power delivered to the load; when said current detection signal reaches said maximum current reference signal, the resistance of said protection circuit is dynamically adjusted by said control circuit to maintain the input current at said predetermined maximum current.

3. The step up converter in claim 1 further including an auxiliary power supply, coupled to a switch node (SW) of said step-up circuit and to supply power to said protection circuit and said control circuit.

4. The step up converter in claim 1 wherein said input current detection circuit is a resistance device.

5. The step up converter in claim 4 wherein said resistance device is selected from the group of a resistor, a switching element, or an inductive device of said step-up circuit.

6. The step up converter in claim 3 wherein said auxiliary power supply is a charge pump.

7. The step up converter in claim 1 wherein said protection circuit comprises a transistor.

8. The step up converter in claim 1 wherein said control circuit further includes a output voltage detection circuit and when a shorted output is detected cuts off the resistance of said protection circuit.

9. The step up converter in claim 1 wherein said control circuit further includes a temperature detection circuit which detects the system temperature and when the temperature is detected to be higher than a predetermined value, cuts off the resistive element of said protection circuit.

10. A step up converter comprising:
input terminal means for connection to a port;
output terminal means for delivering current to a load;
input current detection means coupled to said input terminal means and for outputting a current detection signal;
control means coupled to said input current detection means and receiving the current detection signal, the control means comparing said current detection signal with a maximum current reference signal and outputting a control signal;
step-up means coupled to said input current detection means, the step up means boosting the voltage at said input terminal means to a level required by the load; and
protection means coupled between the step-up means and said output terminal means, the protection means receiving the control signal, and responsive thereto, operative to selectively adjust the resistance of said protection means.

11. The step up converter in claim 10, wherein when said current detection signal is less than said maximum current reference signal, the resistance of the protection means is decreased by said control means to achieve a desired power delivered to the load; when said current detection signal reaches said maximum current reference signal, the resistance of said protection means is dynamically adjusted by said control means to maintain the input current at said predetermined maximum current.

12. The step up converter in claim 10 further including an auxiliary power means, coupled to a switch node (SW) of said step-up means and to supply power to said protection means and said control means.

13. The step up converter in claim 10 wherein said input current detection means is a resistance device.

14. The step up converter in claim 13 wherein said resistance device is selected from the group of a resistor, a switching element, or an inductive device of said step-up circuit.

15. The step up converter in claim 12 wherein said auxiliary power means is a charge pump.

16. The step up converter in claim 10 wherein said protection means is a transistor.

17. The step up converter in claim 1 wherein said control means further includes a output voltage detection means and when a shorted output is detected cuts off the resistance of said protection means.

18. The step up converter in claim 1 wherein said control means further includes a temperature detection means which detects the system temperature and when the temperature is detected to be higher than a predetermined value, cuts off the resistance of said protection circuit.

19. A method of step up conversion between an input terminal and an output terminal, the method comprising:
detecting an input current through said input terminal;
comparing said input current with a maximum current reference signal;
generating a control signal based upon the relative comparison of said input current and said maximum current reference signal;
boosting the voltage at said input terminal to a level required by a load connected to said output terminal; and
providing a protection circuit between the input terminal and the output terminal, the protection circuit receiving the control signal, and responsive thereto, operative to selectively adjust the resistance of said protection circuit.
